(19) United States
(12) Patent Application Publication
(10) Pub. No.: US 2009/0090569 A1
(43) Pub. Date: Apr. 9, 2009

(54) Sensing System

(76) Inventor: Cho-Yi Lin, Hsinchu (TW)

Correspondence Address: HDLS Patent & Trademark Services, P.O. BOX 220746, CHANTILLY, VA, 20153-0746, US

(21) Appl. No.: 12/334,449

(22) Filed: Dec. 13, 2008

Related U.S. Application Data
(63) Continuation-in-part of application No. 11/249,222, filed on Oct. 13, 2005.

(30) Foreign Application Priority Data
Nov. 3, 2008 (TW) 097142355

(51) Int. Cl. G06F 3/042; G08C 21/00

(52) U.S. Cl. 178/18.09; 178/18.03

(57) ABSTRACT

A sensing system includes a panel, a reflective element (RE), an image sensor (IS) and a processor electrically connected to the IS. The panel has a plane, a first area (FIA) having the first, second, third and fourth boundaries connected in order and a third area (TA) at the plane. The TA in the FIA is smaller than the FIA. The FIA and TA are quadrilaterals. The RE on the plane is disposed at the first boundary. A reflective mirror plane (RMP) of the RE perpendicular to the plane mirrors the FIA and TA to form a second area (SA) and a fourth area (FOA). The IS sensing the TA and FOA on the plane is disposed at the intersection of the third and fourth boundaries. An imaginary line passing through the IS, being perpendicular to the RMP and being located on the plane is outside the TA and FOA.

### RELATED APPLICATIONS

This application is a continuation-in-part of U.S. patent application Ser. No. 11/249,222 filed on Oct. 10, 2008.

### BACKGROUND

1. Field of the Invention

The present invention relates to a sensing system, and more particularly, to a sensing system having a reflective element.

2. Description of the Related Art

Touch systems have been disclosed in many patents, such as U.S. Pat. No. 4,782,328 and U.S. Pat. No. 6,803,906. Each of the touch systems disclosed in the above two patents must have at least two sensors, such that the production cost of each of the touch systems disclosed in the patents is relatively high. One of the two patents is described thereinafter in detail.

FIG. 1 is a schematic view of a conventional touch screen system. Referring to FIG. 1, the touch screen system 100 disclosed in the U.S. Pat. No. 4,782,328 includes a panel 110, a first photosensor 120, a second photosensor 130 and a processor 140. The panel 110 has a touch screen area 112 which is a rectangle. The first photosensor 120 and the second photosensor 130 are disposed at two opposite ends of a boundary 112a of the touch screen area 112. The sensing range of the first photosensor 120 and that of the second photosensor 130 cover the whole touch screen area 112 respectively. Furthermore, the first photosensor 120 and the second photosensor 130 are electrically connected to the processor 140.

When a pointer 150 touches the touch screen area 112, the first photosensor 120 senses the pointer 150 along a first sensing path 162 and the second photosensor 130 senses the pointer 150 along a second sensing path 164. The processor 140 calculates the location of the pointer 150 according to the first sensing path 162 and the second sensing path 164.

However, the conventional touch screen system 100 must have the two photosensors 120 and 130, such that the production cost thereof is relatively high.

### BRIEF SUMMARY

The present invention is directed to provide a sensing system of which the production cost is relatively low.

A sensing system adapted to sensing a pointer and calculating a location of the pointer, in accordance with an exemplary embodiment of the present invention, is provided. The sensing system includes a panel, a reflective element, an image sensor and a processor. The panel has a first plane, a first area located at the first plane and a third area located at the first plane. The third area is located in the first area. The first area is quadrangular and has a first boundary, a second boundary, a third boundary and a fourth boundary which are connected in order. The third area is quadrangular. The square measure of the third area is smaller than that of the first area.

The reflective element is disposed at the first boundary and located on the first plane. The reflective element has a second plane substantially perpendicular to the first plane. The second plane is a reflective mirror plane. The second plane mirrors the first area to form a second area and mirrors the third area to form a fourth area. The image sensor is disposed at a corner at which the third boundary and the fourth boundary intersects and located on the first plane. A sensing range of the image sensor covers the third area and the fourth area. An imaginary line passing through the image sensor, being perpendicular to the second plane and being located at the first plane is located outside the third area and the fourth area. The processor is electrically connected to the image sensor.

When the pointer approaches the third area and the pointer is mirrored by the reflective element to form a first mirror image such that the pointer and the first mirror image is in the sensing range of the image sensor, the image sensor senses the pointer and the first mirror image and the processor calculates the location of the pointer.

In an embodiment of the present invention, the image sensor senses the pointer along a first sensing path and senses the first mirror image along a second sensing path, and the processor calculates the location of the pointer according to the first sensing path and the second sensing path.

In an embodiment of the present invention, the first area is a rectangle. In addition, the third area may be a rectangle, and one of four boundaries of the third area is parallel to or coincides with the third boundary of the first area. Furthermore, a center of the third area coincides with that of the first area or two of the boundaries of the third area coincide with the third boundary and the second boundary of the first area respectively. Besides, the third area may be quadrangular and not a rectangle.

In an embodiment of the present invention, the processor has information about a first distance “D1” from the first boundary to the third boundary. The processor calculates the location of the pointer by the following steps. First, a first angle “A1” between the first sensing path and the third boundary is determined. Next, a second angle “A2” between the second sensing path and the third boundary is determined. Next, a second distance “D2” from the pointer to the fourth boundary is calculated by means of dividing the double of D1 by the sum of tanA1 and tanA2.

In an embodiment of the present invention, the sensing system further includes a first linear light source and a second linear light source. The first linear light source is disposed at the second boundary and located on the first plane. The first linear light source is mirrored by the reflective element to form a second mirror image. The second linear light source is disposed at the third boundary and located on the first plane. The second linear light source is mirrored by the reflective element to form a third mirror image. The fourth boundary is mirrored by the reflective element to form a fourth mirror image. The reflective element, the first linear light source, the second linear light source and the fourth boundary surround the first area. The reflective element, the second mirror image, the third mirror image and the fourth mirror image surround the second area. At least part of the first linear light source, at least part of the second mirror image and at least part of the third mirror image are in the sensing range of the image sensor.

In an embodiment of the present invention, the sensing system further includes a first light source, a first reflector and a second reflector. The first light source is disposed beside the image sensor. The first reflector is disposed at the second boundary and located on the first plane. The first reflector is mirrored by the reflective element to form a second mirror image. The first reflector has a first retro-reflective surface and the first retro-reflective surface is adapted to reflecting light emitted from the first light source. The second reflector is disposed at the third boundary and located on the first plane. The second reflector is mirrored by the reflective element to form a third mirror image. The second reflector has a second retro-reflective surface and the second retro-reflective surface is adapted to reflecting the light emitted from the first light source. The fourth boundary is mirrored by the reflective element to form a fourth mirror image. The reflective element, the first reflector, the second reflector and the fourth boundary surround the first area. The reflective element, the second mirror image, the third mirror image and the fourth mirror image surround the second area. At least part of the first reflector, at least part of the second mirror image and at least part of the third mirror image are in the sensing range of the image sensor.

In an embodiment of the present invention, the first light source is adapted to emitting invisible light. The image sensor has an image-sensing window and a filter. The filter is disposed in front of the image-sensing window and the filter filters out other light except the invisible light such that the invisible light passes through the filter. In addition, the first light source is an infrared light emitting diode (IR LED) and the filter is an IR-pass filter.

In an embodiment of the present invention, the sensing system further includes a first light source located above the first plane and outside the third area. The first light source is mirrored by the reflective element to form a second mirror image. The first light source and the second mirror image are located outside the sensing range of the image sensor. The pointer has a reflective surface. The first light source is adapted to emitting invisible light and the first mirror image is formed by means of the first light source illumining the reflective surface of the pointer.

In an embodiment of the present invention, the pointer has a light emitting device. The first mirror image is formed by means of light emitted from the light emitting device.

The processor of the sensing system of the embodiment of the present invention can calculate the location of the pointer by means of employing the reflective element and the image sensor. Therefore, compared with the conventional arts, the sensing system of the present embodiment can employ one image sensor such that the production cost thereof is low.

### BRIEF DESCRIPTION OF THE DRAWINGS

The accompanying drawings are included to provide a further understanding of the invention, and are incorporated in and constitute part of this specification. The drawings illustrate embodiments of the invention and, together with the description, serve to explain the principles of the invention.

FIG. 1 is a schematic view of a conventional touch screen system.

FIG. 2 is a schematic three-dimensional view of a sensing system of a first embodiment of the present invention.

FIG. 3 is a schematic top view of the sensing system of FIG. 2 in operation.

FIG. 4 is a schematic view showing that the processor of FIG. 3 calculates the location of the pointer.

FIG. 5 is a schematic view of an image-sensing window of the image sensor of FIG. 3.

FIG. 6 is a schematic top view of a sensing system of a second embodiment of the present invention.

FIG. 7 is a schematic top view of a sensing system of a third embodiment of the present invention.

FIG. 8 is a schematic three-dimensional view of a sensing system of a fourth embodiment of the present invention.

FIG. 9 is a schematic three-dimensional view of a sensing system of a fifth embodiment of the present invention.

FIG. 10 is a schematic top view of a sensing system in operation of a sixth embodiment of the present invention.

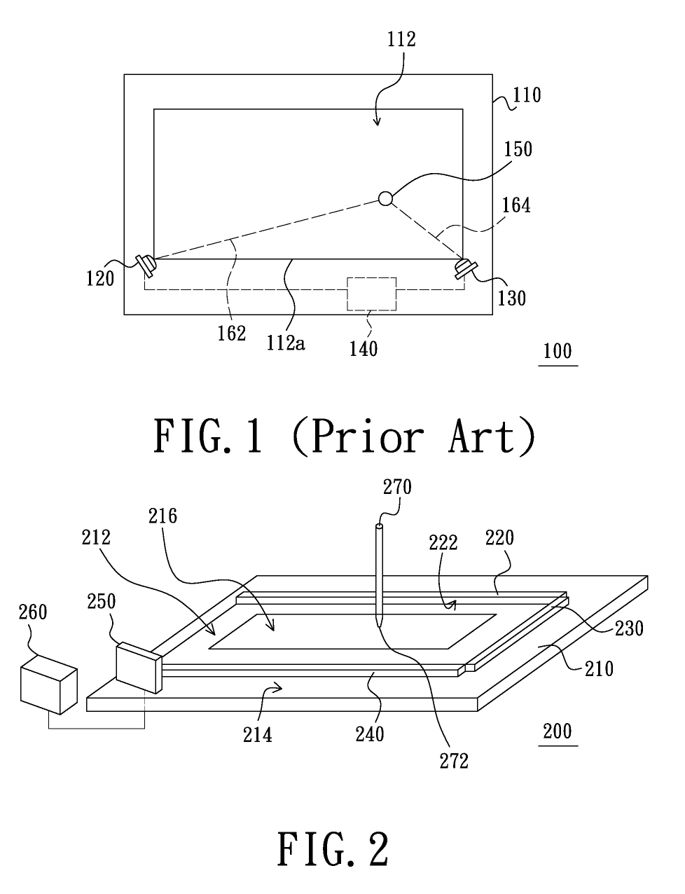

### DETAILED DESCRIPTION

Reference will now be made to the drawings to describe exemplary embodiments of the present sensing system, in detail. The following description is given by way of example, and not limitation.

### First Embodiment

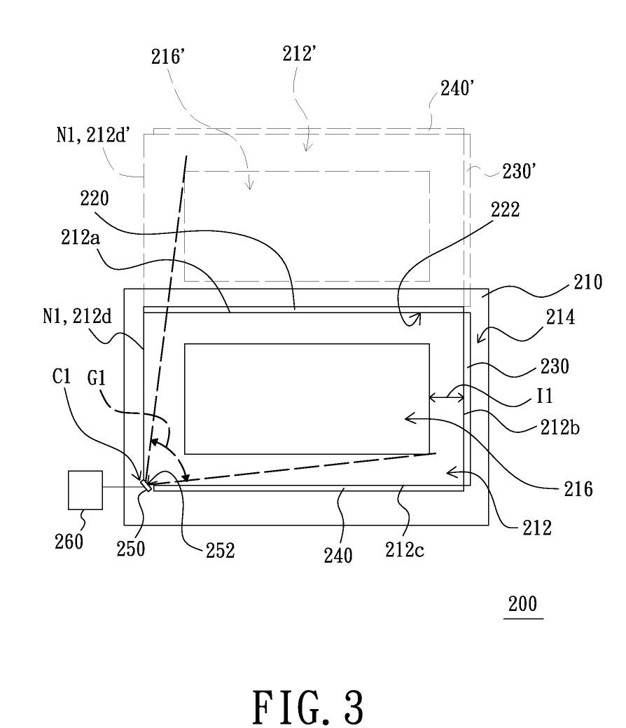

FIG. 2 is a schematic three-dimensional view of a sensing system of a first embodiment of the present invention. FIG. 3 is a schematic top view of the sensing system of FIG. 2 in operation. Referring to FIGS. 2 and 3, the sensing system 200 is adapted to sensing a pointer 270 and calculating the location of the pointer 270 (seeing the following detailed description). The sensing system 200 includes a panel 210, a reflective element 220, a first linear light source 230, a second linear light source 240, an image sensor 250 and a processor 260. The panel 210, such as a whiteboard or a touch screen, has a first plane 214, a first area 212 located at the first plane 214 and a third area 216 located at the first plane 214. The third area 216 is located in the first area 212. The first area 212 is quadrangular, such as a rectangle. Furthermore, the first area 212 has a first boundary 212a, a second boundary 212b, a third boundary 212c and a fourth boundary 212d which are connected in order. The third area 216 is quadrangular, such as a rectangle. The square measure of the third area 216 is smaller than that of the first area 212. In the present embodiment, one of four boundaries of the third area 216 is parallel to the third boundary 212c of the first area 212 and a center of the third area 216 coincides with that of the first area 212. To sum up, an interval I1 is located between the third area 216 and the first area 212 and the interval I1 surrounds the third area 216.

The reflective element 220 is disposed at the first boundary 212a and located on the first plane 214. The reflective element 220 has a second plane 222 substantially perpendicular to the first plane 214. The second plane 222 is a reflective mirror plane. The second plane 222 mirrors the first area 212 to form a second area 212′ and mirrors the third area 216 to form a fourth area 216′. The reflective element 220 may be a plane mirror but not limited in this. The first linear light source 230 is disposed at the second boundary 212b and located on the first plane 214. The first linear light source 230 is mirrored by the reflective element 220 to form a second mirror image 230′.

The second linear light source 240 is disposed at the third boundary 212c and located on the first plane 214. The second linear light source 240 is mirrored by the reflective element 220 to form a third mirror image 240′. The fourth boundary 212d is mirrored by the reflective element 220 to form a fourth mirror image 212d′. The reflective element 220, the first linear light source 230, the second linear light source 240 and the fourth boundary 212d surround the first area 212. The reflective element 220, the second mirror image 230′, the third mirror image 240′ and the fourth mirror image 212d′ surround the second area 212′.

The image sensor 250 is disposed at a corner C1 at which the third boundary 212c and the fourth boundary 212d intersects and located on the first plane 214. A sensing range of the image sensor 250 covers the third area 216 and the fourth area 216′. At least part of the first linear light source 230, at least part of the second mirror image 230′ and at least part of the third mirror image 240′ are in the sensing range of the image sensor 250. In the present embodiment, part of the first linear light source 230, the second mirror image 230′ and part of the third mirror image 240′ are in the sensing range of the image sensor 250. A field angle G1 of the image sensor 250 of the present embodiment may be smaller than 90 degrees. In addition, an imaginary line N1 passing through the image sensor 250, being perpendicular to the second plane 222 of the reflective element 220 and being located at the first plane 214 is located outside the third area 216 and the fourth area 216′. The imaginary line N1 of the present embodiment coincides with the fourth boundary 212d and the fourth mirror image 212d′. In other words, the imaginary line N1 does not pass through the interior of the third area 216 and that of the fourth area 216′. Furthermore, the processor 260 is electrically connected to the image sensor 250.

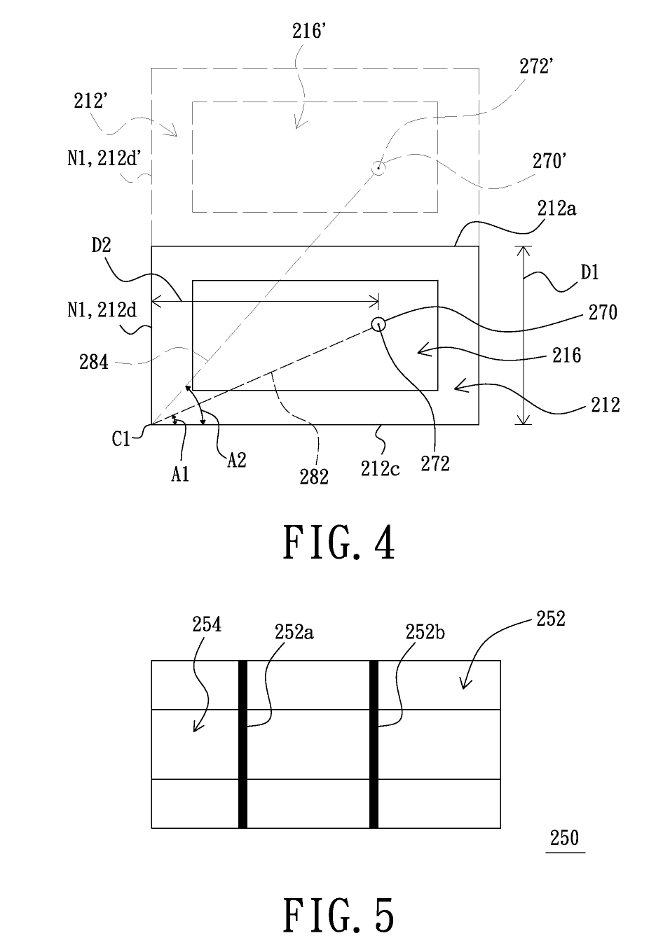

The operation of the sensing system 200 of the present embodiment is described thereinafter. FIG. 4 is a schematic view showing that the processor of FIG. 3 calculates the location of the pointer. FIG. 5 is a schematic view of an image-sensing window of the image sensor of FIG. 3. Referring to FIGS. 3, 4 and 5, when the pointer 270 (as shown in FIG. 2) approaches the third area 216 and the pointer 270 is mirrored by the reflective element 220 to form a first mirror image 270′ such that the pointer 270 and the first mirror image 270′ are in the sensing range of the image sensor 250, the image sensor 250 senses the pointer 270 and the first mirror image 270′ and the processor 260 calculates the location of the pointer 270. Specifically, the image sensor 250 of the present embodiment senses the pointer 270 along a first sensing path 282 and senses the first mirror image 270′ along a second sensing path 284, and the processor 260 calculates the location of the pointer 270 according to the first sensing path 282 and the second sensing path 284.

It should be noted that, in the present embodiment, a portion of the pointer 270 adjacent to the third area 216 is a cusp 272 (as shown in FIG. 2) of the pointer 270, and a portion of the first mirror image 270′ adjacent to the fourth area 216′ is a cusp 272′ of the first mirror image 270′. In addition, because the imaginary line N1 does not pass through the interior of the third area 216 and that of the fourth area 216′, the cusp 272 of the pointer 270 in the third area 216, the cusp 272′ of the first mirror image 270′ in the fourth area 216′ and the image sensor 250 are not colinear.

Concretely, in the present embodiment, the image sensor 250 has an image-sensing window 252. When the pointer 270 does not approach the third area 216, light emitted from the first linear light source 230, the second mirror image 230′ and the third mirror image 240′ illuminates the image-sensing window 252 to form a bright zone 254 with high brightness on the image-sensing window 252. The bright zone 254 is a primary sensing zone. When the pointer 270 approaches the third area 216, the image sensor 250 senses the pointer 270 along the first sensing path 282, a first obscure strip 252a is formed in the bright zone 254 of the image-sensing window 252 and the image sensor 250 outputs a first electrical signal. The processor 260 receives the first electrical signal and determines a first angle A1 between the first sensing path 282 and the third boundary 212c according to the location of the first obscure strip 252a in the image-sensing window 252. In other words, the information about a relationship between the location of the obscure strip in the image-sensing window 252 and the angle between the sensing path and the third boundary 212c may be built in the processor 260 such that the operation for determining the first angle A1 is performed.

Similarly, the image sensor 250 senses the first mirror image 270′ along the second sensing path 284. A second obscure strip 252b is formed in the bright zone 254 of the image-sensing window 252 and the image sensor 250 outputs a second electrical signal. The processor 260 receives the second electrical signal and determines a second angle A2 between the second sensing path 284 and the third boundary 212c according to the location of the second obscure strip 252b in the image-sensing window 252. It should be noted that the higher the brightness of the first linear light source 230 and the second linear light source 240 is, the more obvious the first obscure strip 252a and the second obscure strip 252b in the image-sensing window 252 are.

The information about a first distance D1 from the first boundary 212a to the third boundary 212c may be built in the processor 260. In the present embodiment, the third boundary 212c is defined as the X axis of a Cartesian coordinate system, the fourth boundary 212d is defined as the Y axis of the Cartesian coordinate system, and the coordinate of the corner C1 is (0, 0). The X coordinate of the pointer 270 is a second distance D2 from the pointer 270 to the fourth boundary 212d. The midpoint between the pointer 270 and the first mirror image 270′ is located at the first boundary 212a. Accordingly, D1 is equal to (D2·tanA1+D2·tanA2)/2. Therefore, the processor 260 may calculate the second distance D2 from the pointer 270 to the fourth boundary 212d by means of dividing the double of D1 by the sum of tanA1 and tanA2. In other words, the coordinate (D2, D2·tanA1) of the pointer 270 may be calculated by the above method. It should be noted that the above method for calculating the coordinate of the pointer 270 in the Cartesian coordinate system is given as an example and not intended to limit the present invention. A designer can adapt another coordinate system to calculate the coordinate of the pointer according to the requirement of the designer.

The processor 260 of the sensing system 200 of the present embodiment can calculate the location of the pointer 270 by means of employing the reflective element 220 and the image sensor 250. Therefore, compared with the conventional arts, the sensing system 200 of the present embodiment can employ one image sensor 250 such that the production cost of the sensing system 200 is low.

### Second Embodiment

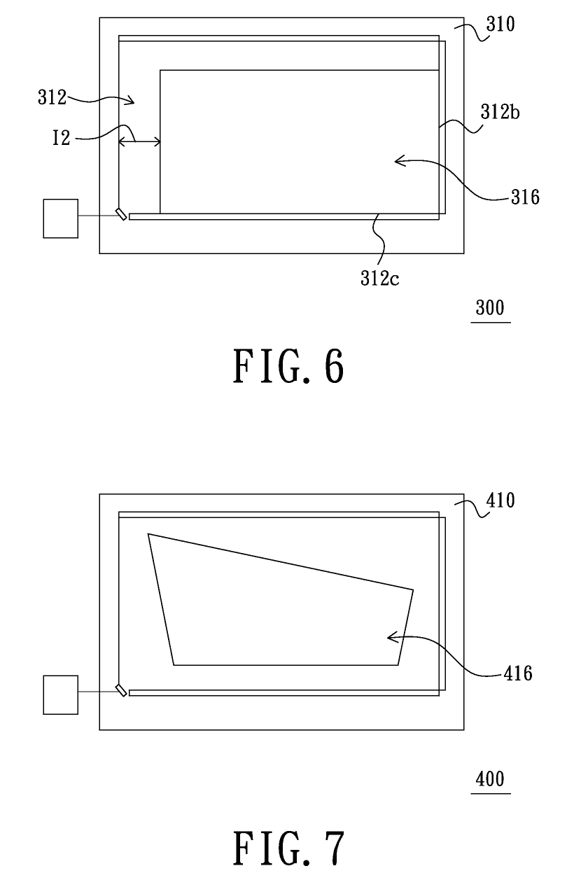

FIG. 6 is a schematic top view of a sensing system of a second embodiment of the present invention. Referring to FIGS. 3 and 6, the difference between the sensing system 300 of the present embodiment and the sensing system 200 of the first embodiment lies in that two of the boundaries of the third area 316 of the panel 310 of the sensing system 300 coincide with the third boundary 312c and the second boundary 312b of the first area 312 respectively. To sum up, an interval I2 is located between the third area 316 and the first area 312 and the interval I2 is L-shaped.

### Third Embodiment

FIG. 7 is a schematic top view of a sensing system of a third embodiment of the present invention. Referring to FIGS. 3 and 7, the difference between the sensing system 400 of the present embodiment and the sensing system 200 of the first embodiment lies in that the third area 416 of the panel 410 of the sensing system 400 is quadrangular and not a rectangle.

### Fourth Embodiment

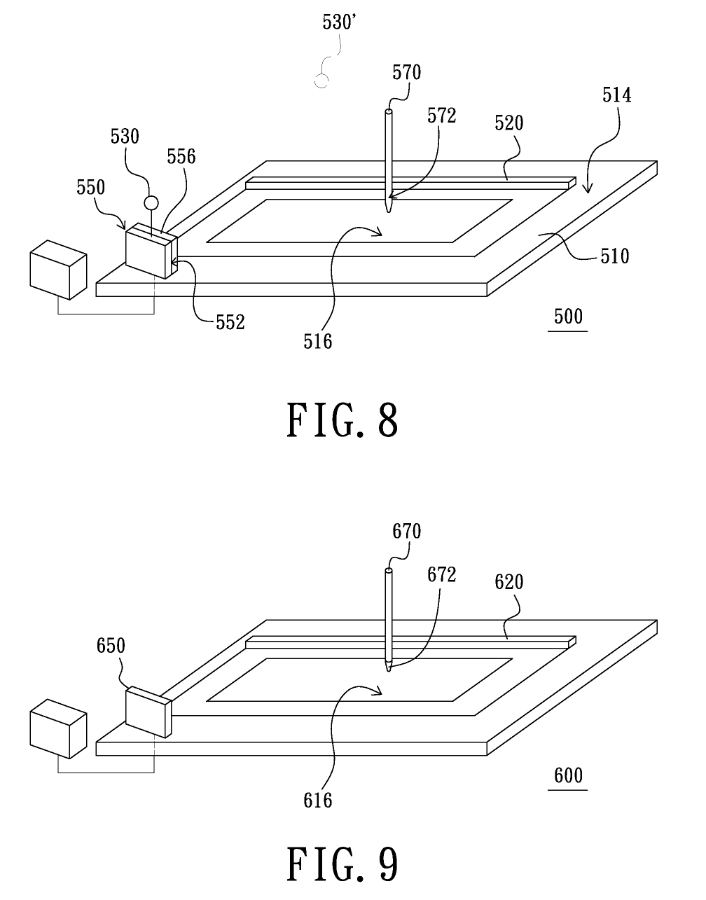

FIG. 8 is a schematic three-dimensional view of a sensing system of a fourth embodiment of the present invention. Referring to FIGS. 2 and 8, the difference between the sensing system 500 and the sensing system 200 lies in that the first linear light source 230 and the second linear light source 240 are omitted in the sensing system 500. The sensing system 500 includes a first light source 530 located above the first plane 514 of the panel 510 and outside the third area 516. The first light source 530 is mirrored by the reflective element 520 to form a second mirror image 530′. The first light source 530 and the second mirror image 530′ are located outside the sensing range of the image sensor 550. The pointer 570 has a reflective surface 572 which may be coated by a reflective material. The reflective material of the reflective surface 572 meets the Europe Standard of EN471 but is not limited in this.

The first light source 530 is adapted to emitting invisible light, such as infrared light with the wavelength of about 940 nm. The first mirror image (not shown) corresponding to the pointer 570 mirrored by the reflective element 520 is formed by means of the first light source 530 illumining the reflective surface 572 of the pointer 570. The image sensor 550 may include a filter 556 located in front of the image-sensing window 552. The pointer 570 can reflect the invisible light to the filter 556. The filter 556 is adapted to filtering out other light such that the image-sensing window 552 receives the invisible light reflected by the pointer 570. In addition, the image sensor 550 can also sense the first mirror image (not shown) of the pointer 570.

It should be noted that the third area 516 may be quadrangular and not a rectangle, but not shown in any drawing.

### Fifth Embodiment

FIG. 9 is a schematic three-dimensional view of a sensing system of a fifth embodiment of the present invention. Referring to FIGS. 2 and 9, the difference between the sensing system 600 and the sensing system 200 lies in that the first linear light source 230 and the second linear light source 240 are omitted in the sensing system 600. The pointer 670 has a light emitting device 672 and the first mirror image (not shown) is formed by means of the light emitted from the light emitting device 672. The image sensor 650 can sense the pointer 670 and the first mirror image (not shown) corresponding to the pointer 670 mirrored by the reflective element 620.

It should be noted that the third area 616 may be quadrangular and not a rectangle, but not shown in any drawing.

### Sixth Embodiment

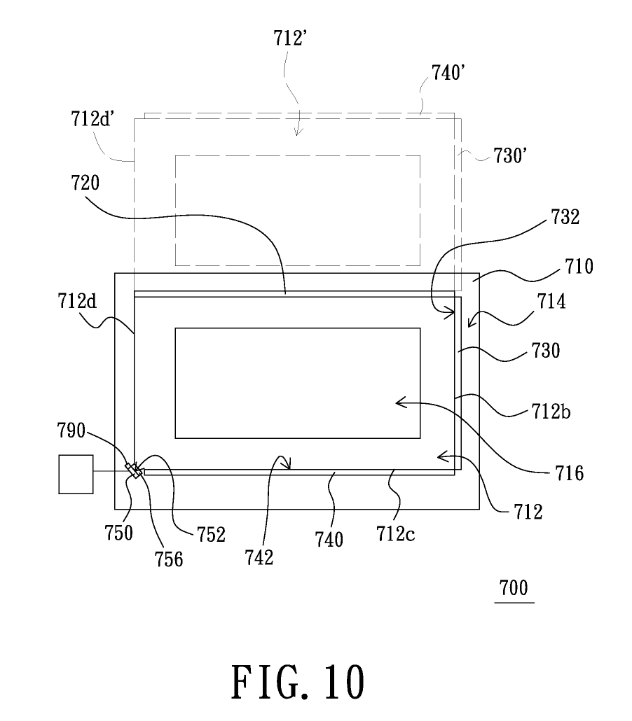

FIG. 10 is a schematic top view of a sensing system in operation of a sixth embodiment of the present invention. Referring to FIGS. 3 and 10, the difference between the sensing system 700 and the sensing system 200 lies in that the first linear light source 230 and the second linear light source 240 are omitted in the sensing system 700. The sensing system 700 further includes a first light source 790, a first reflector 730 and a second reflector 740. The first light source 790 is disposed beside the image sensor 750. The first light source 790 such as an infrared light emitting diode (IR LED) is adapted to emitting invisible light such as IR light. The image sensor 750 may have a filter 756 such as an IR-pass filter disposed in front of the image-sensing window 752. The IR light can pass through the filter 756.

The first reflector 730 is disposed at the second boundary 712b of the first area 712 of the panel 710 and located on the first plane 714 of the panel 710. The first reflector 730 is mirrored by the reflective element 720 to form a second mirror image 730′. The first reflector 730 has a first retro-reflective surface 732 and the first retro-reflective surface 732 is adapted to reflecting light emitted from the first light source 790. That is, the first reflector 730 may be composed of retro-reflective material.

The second reflector 740 is disposed at the third boundary 712c of the first area 712 of the panel 710 and located on the first plane 714 of the panel 710. The second reflector 740 is mirrored by the reflective element 720 to form a third mirror image 740′. The second reflector 740 has a second retro-reflective surface 742 and the second retro-reflective surface 742 is adapted to reflecting the light emitted from the first light source 790. That is, the second reflector 740 may be composed of retro-reflective material.

The fourth boundary 712d of the first area 712 of the panel 710 is mirrored by the reflective element 720 to form a fourth mirror image 712d′. The reflective element 720, the first reflector 730, the second reflector 740 and the fourth boundary 712d surround the first area 712. The reflective element 720, the second mirror image 730′, the third mirror image 740′ and the fourth mirror image 712d′ surround the second area 712′. At least part of the first reflector 730, at least part of the second mirror image 730′ and at least part of the third mirror image 740′ are in the sensing range of the image sensor 750.

The first light source 790 such as the IR LED emits the IR light. The first retro-reflective surface 732 of the first reflector 730 and the second retro-reflective surface 742 of the second reflector 740 reflect the IR light. In other words, the function of the first retro-reflective surface 732 and that of the second retro-reflective surface 742 are similar to the first linear light source 230 and the second linear light source 240 of the first embodiment respectively. It is not repeated herein. Accordingly, the pointer (not shown) and the first mirror image (not shown) form the first obscure strip (not shown) and the second obscure strip (not shown) respectively in the image-sensing window 752 of the image sensor 750. The related description can be referred to the content of the first embodiment and it is not repeated herein.

It should be noted that the third area 716 may be quadrangular and not a rectangle, but not shown in any drawing.

In summary, the sensing system of each of the embodiments of the present invention has the following advantages or other advantages. The processor of the sensing system of each of the embodiments of the present invention can calculate the location of the pointer by means of employing the reflective element and the image sensor. Therefore, compared with the conventional arts, the present sensing system can employ one image sensor such that the production cost of the sensing system of each of the embodiments of the present invention is low.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A sensing system adapted to sensing a pointer and calculating a location of the pointer, comprising:
a panel having a first plane, a first area located at the first plane and a third area located at the first plane, wherein the third area is located in the first area, the first area is quadrangular and has a first boundary, a second boundary, a third boundary and a fourth boundary which are connected in order, the third area is quadrangular, and the square measure of the third area is smaller than that of the first area;
a reflective element disposed at the first boundary and located on the first plane, wherein the reflective element has a second plane substantially perpendicular to the first plane, the second plane is a reflective mirror plane and mirrors the first area to form a second area, and the second plane mirrors the third area to form a fourth area;
an image sensor disposed at a corner at which the third boundary and the fourth boundary intersects and located on the first plane, wherein a sensing range of the image sensor covers the third area and the fourth area, and an imaginary line passing through the image sensor, being perpendicular to the second plane and being located at the first plane is located outside the third area and the fourth area; and
a processor electrically connected to the image sensor;
wherein when the pointer approaches the third area and the pointer is mirrored by the reflective element to form a first mirror image such that the pointer and the first mirror image is in the sensing range of the image sensor, the image sensor senses the pointer and the first mirror image and the processor calculates the location of the pointer.

2. The sensing system as claimed in claim 1, wherein the image sensor senses the pointer along a first sensing path and senses the first mirror image along a second sensing path, and the processor calculates the location of the pointer according to the first sensing path and the second sensing path.

3. The sensing system as claimed in claim 2, wherein the first area is a rectangle.

4. The sensing system as claimed in claim 3, wherein the third area is a rectangle, and one of four boundaries of the third area is parallel to or coincides with the third boundary of the first area.

5. The sensing system as claimed in claim 4, wherein a center of the third area coincides with that of the first area.

6. The sensing system as claimed in claim 4, wherein two of the boundaries of the third area coincide with the third boundary and the second boundary of the first area respectively.

7. The sensing system as claimed in claim 3, wherein the third area is quadrangular and not a rectangle.

8. The sensing system as claimed in claim 3, wherein the processor has information about a first distance “D1” from the first boundary to the third boundary, and the processor calculates the location of the pointer by the steps of:
determining a first angle “A1” between the first sensing path and the third boundary;
determining a second angle “A2” between the second sensing path and the third boundary; and
calculating a second distance “D2” from the pointer to the fourth boundary by means of dividing the double of D1 by the sum of tanA1 and tanA2.

9. The sensing system as claimed in claim 3, further comprising:
a first linear light source disposed at the second boundary and located on the first plane, wherein the first linear light source is mirrored by the reflective element to form a second mirror image; and
a second linear light source disposed at the third boundary and located on the first plane, wherein the second linear light source is mirrored by the reflective element to form a third mirror image, the fourth boundary is mirrored by the reflective element to form a fourth mirror image, the reflective element, the first linear light source, the second linear light source and the fourth boundary surround the first area, the reflective element, the second mirror image, the third mirror image and the fourth mirror image surround the second area, and at least part of the first linear light source, at least part of the second mirror image and at least part of the third mirror image are in the sensing range of the image sensor.

10. The sensing system as claimed in claim 3, further comprising:
a first light source disposed beside the image sensor;
a first reflector disposed at the second boundary and located on the first plane, wherein the first reflector is mirrored by the reflective element to form a second mirror image, the first reflector has a first retro-reflective surface, and the first retro-reflective surface is adapted to reflecting light emitted from the first light source; and
a second reflector disposed at the third boundary and located on the first plane, wherein the second reflector is mirrored by the reflective element to form a third mirror image, the second reflector has a second retro-reflective surface, the second retro-reflective surface is adapted to reflecting the light emitted from the first light source, the fourth boundary is mirrored by the reflective element to form a fourth mirror image, the reflective element, the first reflector, the second reflector and the fourth boundary surround the first area, the reflective element, the second mirror image, the third mirror image and the fourth mirror image surround the second area, and at least part of the first reflector, at least part of the second mirror image and at least part of the third mirror image are in the sensing range of the image sensor.

11. The sensing system as claimed in claim 10, wherein the first light source is adapted to emitting invisible light, the image sensor has an image-sensing window and a filter, the filter is disposed in front of the image-sensing window, and the filter filters out other light except the invisible light such that the invisible light passes through the filter.

12. The sensing system as claimed in claim 11, wherein the first light source is an infrared light emitting diode (IR LED) and the filter is IR-pass filter.

13. The sensing system as claimed in claim 2, further comprising a first light source located above the first plane and outside the third area, wherein the first light source is mirrored by the reflective element to form a second mirror image, the first light source and the second mirror image are located outside the sensing range of the image sensor, the pointer has a reflective surface, the first light source is adapted to emitting invisible light, and the first mirror image is formed by means of the first light source illumining the reflective surface of the pointer.

14. The sensing system as claimed in claim 2, wherein the pointer has a light emitting device, and the first mirror image is formed by means of light emitted from the light emitting device.
